(19) United States
(12) Patent Application Publication
(10) Pub. No.: US 2010/0039496 A1
(43) Pub. Date: Feb. 18, 2010

(54) Video Conferencing Using Affiliated Displays

(76) Inventors: Saied Kazemi, Irvine, CA (US); Reza Sadri, Irvine, CA (US)

Correspondence Address: FISH & ASSOCIATES, PC;ROBERT D. FISH, 2603 Main Street, Suite 1000, Irvine, CA, 92614-6232, US

(21) Appl. No.: 12/190,474

(22) Filed: Aug. 12, 2008

(51) Int. Cl. H04N 7/14

(52) U.S. Cl. 348/14.08; 348/E07.083

(57) ABSTRACT

Methods for providing video conferencing through network enabled electronic displays are presented. Each of a plurality of displays, preferably digital picture frames, is assigned an identifier used to identify the displays for a video conferencing session. The displays can form a group affiliation as a function of their identifier and can be packaged for sale as a group. Consumers can purchase a package of affiliated displays preconfigured to support a video conference among each other. During a video conferencing session the affiliated displays are allowed to exchange video conferencing data through an intermediary video conferencing server or directly with each other.

### FIELD OF THE INVENTION

The field of the invention is coordinated image displays.

### BACKGROUND

The use of video conferencing or video chatting continues to grow in many markets. Unfortunately, in consumer markets, video conferencing has failed to gain substantial market traction among individuals lacking technical expertise. Current video conferencing technology available to consumers has numerous limitations. For example, video conferencing services including Skype™ (http://www.skype.com) offer video conferencing services to consumers; however, such services require user registration and the use of a general purpose computer system. Users wishing to avoid registration or lacking computers would likely refuse to use such services. Other companies offer dedicated video conferencing equipment, for example Polycom™ of Pleasanton, Calif. (http://www.polycom.com). Such dedicated equipment is expensive and complex to configure, which places such a solution of the reach of most consumers. Ideally, consumers should be able to purchase a group of devices that can be preconfigured with a group affiliation and that support video conferencing among members of the affiliation.

Others have attempted to create simplified video conferencing solutions in the past. For example, U.S. Patent Publication 2005/0086358 to Rosenberg filed Apr. 28, 2004, offers a method for communicating video data without use of an intermediary server. Hosts exchange video data by identifying each other through the use of host identifiers and sequence numbers. However, Rosenberg fails to address providing a group of video conferencing devices that consumers can utilize quickly.

European Patent EP 01868347 to Huber et al. filed Jun. 14, 2007, also discusses methods of video conferencing among nodes over a network. Huber also fails to address offering consumers a package of video conferencing devices having a group affiliation.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

What has yet to be appreciated is that network enabled electronic displays (e.g., digital picture frames, monitors, etc. . . . ) can be packaged for sale as a group where members of the group can be pre-configured for video conferencing among each other. Members of the group can identify each other without requiring a consumer to register with a service.

Thus, there is still a need for providing devices capable of supporting a video conference among affiliated devices.

### SUMMARY OF THE INVENTION

The present invention provides apparatus, systems and methods in which electronic displays can be packaged for sale as a group where the members of the group can exchange video conferencing data with each other. In some embodiments, member displays exchange data through an intermediary server external to the group, and in other embodiments the member displays exchange video conferencing data directly among each other without requiring an intermediary server.

In one aspect of the inventive subject matter a group of electronic displays, digital picture frames for example, are each assigned identifiers. The members of the group form a group affiliation based on the identifiers. In some embodiments, the identifiers of the each member can comprise a common value representing their group affiliation. Members of the group can be packaged for sale as a group. Once the member displays are deployed, the members are allowed to exchange image and/or audio data among each other in support of a video conference.

The identifiers assigned to each display are contemplated to comprise various advantageous properties. An identifier can be segmented to have multiple portions in a hierarchical manner. Each level of the hierarchy can be used to access group display capabilities by bypassing authentication or permission levels associated with a group interoperability policy.

Various objects, features, aspects and advantages of the inventive subject matter will become more apparent from the following detailed description of preferred embodiments, along with the accompanying drawings in which like numerals represent like components.

### BRIEF DESCRIPTION OF THE DRAWING

FIG. 1 is a schematic overview of an electronic display.

FIG. 2 is a schematic of an exemplary display identifier.

FIG. 3A is a schematic of a plurality of electronic displays packaged for sale.

FIG. 3B is a schematic of offering a plurality of electronic displays for sale on a web site where the selected displays can be packaged as a group affiliation.

FIG. 4 is a schematic of multiple groups of displays enabled to conduct video conferencing over geographic distances using a network.

### DETAILED DESCRIPTION

Electronic Displays

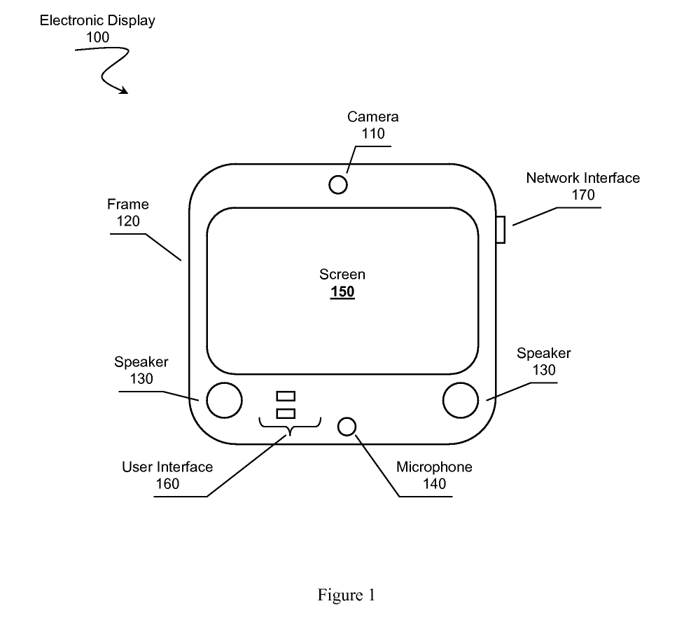

In FIG. 1, electronic display 100 preferably includes one or more components disposed within frame 120 that can collect, exchange, or present video conferencing data. Camera 110 collects image data and microphone 140 collects audio data from a local environment during a conferencing session. The collected data can be sent to remote displays 100 via network interface 170. Display 100 also receives data from one or more remote displays via network interface 170. Received video data can be displayed on screen 150 and audio data can be played back to a local user through one or more of speakers 130. User interface 160 can also be incorporated into display 100 to allow users to control display 100 or even to control a remote display 100.

Although the components of display 100 are illustrated as being disposed within frame 120, it is also contemplated that the components can be external to display 100 while also being communicatively coupled to display 100 via appropriate connectors or ports as are well known in the art. The components can be connected via wired (e.g., USB, Firewire, Ethernet, serial cable, parallel cable, etc. . . . ) or wireless (e.g., wireless USB, Bluetooth, 802.11, WiMAX, IrDA, WirelessHD, ZigBee, Wibree, UWB, etc. . . . ) connections.

Camera 110 preferably comprises a digital charged coupled device (CCD) camera supporting sufficient resolution to capture image data of a local environment with acceptable detail. Preferred resolutions support at least two megapixels, more preferably at least five megapixels. It is also contemplated that camera 110 can comprise different types of lenses to capture additional image data than would not ordinarily be captured. For example, camera 110 can comprise a circular fisheye lens to capture a 180 degree hemispherical view of the local environment. A remote display can rectify the image through software for display on its screen 150. Additionally, a remote user can logically pan or tilt the image as desired through software without requiring physical movement of the camera or disturbing the view of another remote user participating in the conference.

Microphone 140 captures audio data of the local environment. In a preferred embodiment, microphone 140 is integral to display 100. However, it is also contemplated that microphone 140 can be external to display 100 and could include a head set for improved reception. Audio data collected from microphone 140 can be combined with captured image data from camera 110 to create a local video conference data set that can be transmitted to remote displays over network interface 170.

Screen 150 is preferably at least partially housed within frame 120. Screen 150 can comprise a digital display capable of having a sufficient resolution to provide an acceptable rendering of the remotely captured image data. Additionally, it is contemplated that screen 150 can comprise a touch sensitive screen that can be used as interface 160. Preferred resolutions are at least 480 pixels by 640 pixels, and more preferably capable of displaying high definition quality images (e.g., 1280×720 pixels, 1440×1080 pixels, 1920×1080 pixels, or more). Screen 150 can be of any aspect ratio including 5×3, 16×9, or other aspect ratios. A preferred screen 150 comprises an approximately rectangular shape. However, it is also contemplated that screen 150 could be presented to a consumer as having other shapes including circular, triangular, hexagonal, or any other desirable shape. Contemplated digital displays can comprise displays based on technologies including liquid crystal displays (LCDs), plasma displays, digital light processing (DLPs), or others known or yet to be inventive.

Just as screen 150 provides a display of remotely captured image data, one or more of speakers 130 provide audio output of remotely captured audio data. In some embodiments, the number of speakers 130 included with display 100 corresponds to the number displays 100 packaged for sale with a group affiliation. Having multiple speakers enhances the video conferencing experience by assigning a speaker to each remote display. Such an approach ensures that the audio data captured from different remote displays 100 does not interfere with each other and also provides a simulation that audio from the remote sites come from different locations as would be the case if individuals where in the same room speaking with each other.

User interface 160 allows a local user to interact with display 100 to command, control, configure, or otherwise manage display 100. In some embodiments interface 160 comprises one or more physical components (e.g., buttons, knobs, etc. . . . ) integral to display 100. In other embodiments, interface 160 can also include one or more virtual components possibly displayed on a touch sensitive screen 150. It is also contemplated, that user interface 160 can include a web interface accessible by network interface 170 and through which a local user can interact with display 100.

Network interface 170 provides display 100 connectivity to external devices including remote displays 100. Interface 170 can be wired (e.g., USB, Firewire, Ethernet, serial cable, parallel cable, etc. . . . ) or wireless (e.g., wireless USB, Bluetooth, 802.11, WiMAX, IrDA, WirelessHD, ZigBee, Wibree, UWB, etc. . . . ). In a preferred embodiment, interface 170 can connect to a network (e.g., LAN, WAN, VPN, intranet, Internet, etc. . . . ) and access remote devices using known methods or protocols including SIP, H.323, HTTP, or other known protocols.

One skilled in the art will recognize that electronic display 100 comprises one or more electronic elements including a processor, memory, power elements, or other components. In a preferred embodiment, display 100 includes sufficient software, firmware, operating system, or applications to operate as a video conference portal. For example, display 100 could run an embedded Linux OS and a video conferencing application. For example, an application can include code adapted from OpenMeetings (http://code.google.com/p/openmeetings/), an open source video conferencing application. Preferably display 100 comprises a persistent memory (e.g., flash, solid state disk, hard disk, non-volatile RAM, etc. . . . ) used for long term storage of data including a display identifier that corresponds to display 100. Display identifiers will be discussed in greater detail below.

A preferred display 100 comprises a digital picture frame (DPF) configured to display images. Examples of acceptable DPFs include those developed and sold by Digitial Spectrum Solutions, Inc. of Irvine, Calif. (http://www.dsicentral.com/). DPFs are discussed extensively in the literature including co-owned U.S. Pat. No. 6,826,863 titled “Combination Video Monitor And Detachable Picture Frame” and co-owned U.S. patent application having Ser. No. 11/118,009 titled “Method For Pulling Images From the Internet For Viewing On A Remote Digital Display”.

In some embodiments, display 100 comprises a portable DPF having a battery power supply and a wireless network interface 170. Users can transport the portable DPF around the home or office as desired during a video conference. When finished with the conference, the DPF can be placed back in a recharging cradle on a table, desk, wall, or other surface.

Display Identifiers

As previously mentioned, each display 100 is assigned an identifier that can be used to form a group affiliation among two or more displays. Display identifiers are preferably stored within display 100 in a non-volatile memory (e.g., flash, ROM, hard disk, memory card, solid state disk, etc. . . . ). In some embodiments, a display's identifier is a read-only object and can not be overwritten or changed. However, in preferred embodiment a display's identifier can be changed, updated, overwritten, or even deleted once proper authentication is achieved or permission has been granted.

Providing a read-write identifier allows for adding or removing displays from a group affiliation. For example, an old display can have its identifier deleted or changed, and then the display can be sold in a garage sale. The display would no longer be identified as belonging to its previous group.

Preferred identifiers comprise at least 48 bits, more preferably at least 64 bits, or more yet preferably at least 128 bits. One can assign identifiers to display 100 through various suitable methods including using a MAC address associated with network interface 170, assigning the display a globally unique identifier (GUID) and storing the GUID in a memory of display 100, or using an identifier of a component within display 100. Contemplated components having accessible identifiers can include real-time clocks, memory chips, processors, or other physical components.

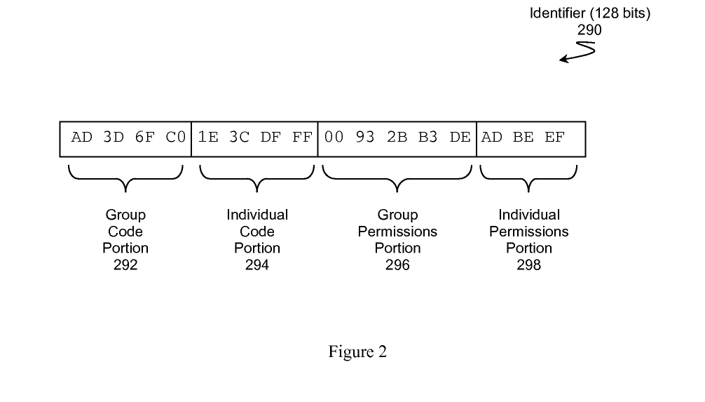

Identifiers can be segmented into multiple portions where each portion comprises one or more bits. Each portion preferably corresponds to permission level granted to display 100 with respect to the interoperability of a group affiliation to which display 100 belongs. FIG. 2 presents an example of identifier 290 with 128 bits segmented into multiple portions. Portion 292 can be used to represent a group code identifying, preferably uniquely, a group affiliation to which a display belongs. Portion 294 can be used to indicate a specific display within the group. Portion 296 could be used to represent the permissions (e.g., accessible functions or privileges) that a display has with respect to the group interoperability. Portion 298 could be used to represent the permissions that a display has with respect to itself. One skilled in the art will recognize that an identifier can be segmented to any number of portions and that each portion can have any reasonable number of bits. In a preferred embodiment, segments of an identifier correspond to capabilities defined by a policy that governs the interoperability to a group of displays. Interoperability policies will be discussed in greater detail below.

In a preferred embodiment, identifier 290 can be organized in a hierarchical fashion where each level in the hierarchy can correspond to a bypass permission or access level of an interoperation policy. For example, an identifier could have the form of “A.B.C.D.E” where each letter represents an access level or a bypass permission of the policy. The “A” level could represent a group level access; the “B” level could represent a sub-group access, and so on. A display with an identifier of “v.w.x.y.z” could bypass various procedures (e.g., authentication, authorization, etc. . . . ) when communicating with other displays having identifiers of the form “v.*.*.*.*” where “*” denotes a wild card having any reasonable value. To continue the example, the display could also bypass procedures for accessing functionality on displays having identifiers of the form “v.w.*.*.*”. One skilled in the art will recognize that any number of levels can be implemented as desired.

One should note that identifiers are associated with the displays as opposed to individuals using the displays. Such an approach allows users to remain anonymous with respect to using a video conferencing service and does not require an individual login to the service. However, it is also contemplated that in some embodiments it would be advantageous for associating a person with one or more displays. For example, a user or owner could be registered with their displays to configure, manage, update, bill, or to have other interactions with their displays or video conferencing service. It should be noted that it is not necessary to register a user for a video conferencing system to operate.

Identifiers are preferably machine readable encoded values. However, it is also contemplated that identifiers can be human readable values including text strings. For example, a display could have a hierarchical identifier similar to “Smith Family.Los Angeles.John's House.Display 1”. In this example, the display belongs to a group affiliation called the “Smith Family” and is located in Los Angeles at John Smith's house. The display is the first display in John's house.

Group Affiliation

A group affiliation represents an identified partner ship among two or more displays. A group affiliation can be formed among multiple displays as a function of their identifiers. In some embodiments, the affiliation can simply be formed as a list of display identifiers (e.g., an array). In other embodiments, an affiliation can be formed from displays assigned identifiers that comprise portions with common values (e.g., group code portion 292), or assigned identifiers that have the same value. Any suitable method for identifying a plurality of displays as having a group affiliation can be used. In a preferred embodiment, a display has a single group affiliation. However, it is also contemplated that a display can have multiple group affiliations, where the additional affiliations can also be established before or even after purchase.

A group affiliation preferably includes one or more group identifiers. A group identifier can be segmented in a similar fashion as a display identifier, or simply have a single value. Group identifiers can be machine readable, human readable, or a combination of both. Consider for example a case where a family purchases a group of frames. A video conferencing service can identify the group by a family name as mapped to a unique group identifier. The service can use the unique identifier for internal video conferencing purposes, including establishing connections among displays, while the individuals within the family can use the family name to manage the group. A video conferencing service simply maps a human readable family name to a machine readable group identifier.

A group affiliation can be formed before or after sale of displays. However, in a preferred embodiment, multiple displays are formed into a group affiliation before sale of the displays.

In a preferred embodiment, an individual can manage a group affiliation. The individual can conduct management activities through a display, preferably a member of the group affiliation. The individual can access management functions through a user interface provided by the display, possibly a web page provided by a remote video conferencing service. Preferred group management functions include creating a group affiliation, destroying a group affiliation, adding a display to a group affiliation, removing a display from a group affiliation, or other group related functions.

In some embodiments, a group affiliation can have a display operate as a group leader. The group leader instructs other members of the displays how to interact during a video conference. In preferred embodiments having a group leader, members of a group affiliation send their image or audio data to the group leader which then forwards the data to other members participating in a video conference. The group leader can be identified via its identifier, possibly by a portion of its identifier associated with group leader permission levels.

Interoperation Policies

In a preferred embodiment, a group affiliation has one or more associated interoperation policies. A policy represents rules that govern interoperation among affiliated displays. Preferred policies can be stored as data within memory of a video conferencing service (e.g., video conferencing server, registration server, etc. . . . ), or within memory of one or more displays. In some embodiments, the policies are represented as flags that indicate which group-related functions that a display is permitted to execute. In other embodiments, a policy can comprise code that can be uploaded to and executed by a display upon grant of permission.

Policy rules can relate to a group affiliation, sub-groups within the affiliation, or even individual displays. Group affiliation rules can include permissions to establish a video conferencing session, to add or remove displays, to define or alter interoperation policies, or to manage other aspects the affiliation. Examples of sub-group rules can include permissions to establish sessions among a subset of displays, to exclude other member displays from a session, or to manage other rules relating to a sub-group. Examples of rules relating to individual displays include permissions to schedule display event, to configure display preferences, to toggle image or audio capture on or off, or to control features relating to an individual display.

Preferred policies are organized in a hierarchical manner where each level of the hierarchy can provide permission to access various group video conferencing functions. In a hierarchical policy, once a display has permission to access the functionality at a specific level, the display also has permission to access functionality at other levels that are considered less restricted. For example, a policy could have three levels. The first level could offer access to very basic functionality including initiating a video conferencing session. The second level could offer access to medium level functionality including configuration of group preferences. If a display has permission to the medium level functions, it would also have access to the basic level functions. The third level could offer access to restricted functions possibly including adding or removing members from the group. Should a member have permission to access the restriction functions, the member would inherit the permission of the low level functions, bypassing permission of the low level function. One skilled in the art will recognize that a policy can have any number of access levels.

As previously discussed a display identifier can also comprise hierarchical levels. In a preferred embodiment, a level of the identifier can correspond to one or more levels of a policy having permissions arranged in a hierarchical manner. A specific level of a display identifier having an appropriate value can gain permission to access functions allowed by a policy at a corresponding policy level. Additionally, the specific level of the display identifier can also gain access to functions allowed by lower policy levels that are less restricted. More specifically, an identifier level that grants access to a high level functions of a policy represents a bypass permission with respect to low levels of the policy. For example, authentication or authorization steps can be bypassed through one or more bypass permissions, which reduces overhead for establishing a video conference, and increases the perceived responsiveness of the system from the perspective of a user.

Policies can be represented by data or software modules that are accessible to displays of a group affiliation, or members of the affiliation having appropriate permission. A group policy can be stored local to each display, remote to displays, or on a video conferencing service. In some embodiments, a group leader can store the policy for a group. In other embodiments, a policy can be stored on a group registration server.

Polices also preferably represent manageable objects. A policy can be created, deleted, updated, or otherwise configured. Additionally, rules can be added or removed from policies once appropriate permission has been granted. In some embodiments, a display offers an interface to manage polices over a network. In other embodiments, users can login to a video conferencing service via a web browser, possibly to a group registration server, to manage policies.

Once a policy is suitably configured, the policy can be updated on the member displays. Displays can be updated by pushing or pulling the policy. When pulling, a display could poll a remote host (e.g., remote server, or a group leader) to determine if a new policy is available. If the policy is available, the display can then download the policy to its memory. In a pushing approach, a remote host storing the policy can connect to member displays when appropriate and upload the policy to the displays. Policies can also comprise time stamps to indicate when the policy has been updated. Additionally, a policy can also comprise an identifier. Displays can store the identifier of the policy as opposed to storing the complete policy or a portion of the policy. In such an approach a display does not necessarily require an update, but rather merely access the current version of the policy from a remote host.

Packaging for Sale

In a preferred embodiment, member displays of a group affiliation are packaged for sale as group. As used herein “packaging” should be broadly interpreted as grouping displays together as a single group that could be purchased. In a preferred embodiment, displays packaged for sale have the same group affiliation. Displays can be physically bound as a package or logically bound as a package.

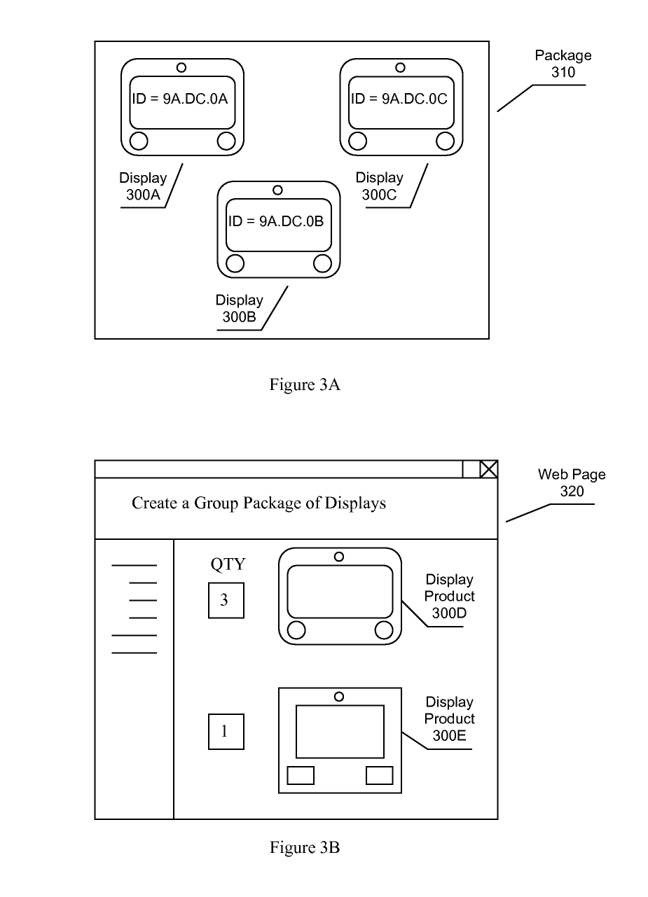

In FIG. 3A, a group of two or more of displays 300A through 300C are packaged for sale within a physical package 310. Package 310 can include a single box having displays suitable for retail sale within a store, a bundle of individual displays packaged together, or other form of packaging. Displays 300A through 300C have been assigned identifiers “9A.DC.0A” through “9A.DC.0C”, respectively. In this example, the displays are associated with a group affiliation identified using the common values from the display identifiers “9A.DC”. When displays 300A through 300C have a video conferencing session, they can identify each other as members of the same group affiliation via their identifiers.

FIG. 3B illustrates another possible example packaging displays in a logical group. Displays 300D and 300E can be offered for sale through web page 320. A consumer can identify which displays they wish to have packaged as a group regardless of the make or models of the displays. One should note that the consumer can also select a quantity of each display to be purchased as shown. When the consumer purchases the displays, a group affiliation can be formed from among the displays as a function of each display's identifier. The displays can then be sent directly to the consumer or possibly shipped to different locations (e.g., different family members, different corporate offices, etc. . . . ). It is also contemplated that web page 320 could provide an interface to establish or to create the group affiliation. The identifiers of the displays 300D and 300E can be stored along with the group affiliation on a video conferencing service.

Packages are contemplated to include two or more displays. Although FIGS. 3A and 3B illustrate packages of a small number of displays, it is specifically contemplated that displays can be packaged in any number. Preferred packages for sale in a retail space include two, three, four or five displays. Even more than five displays having a group affiliation can be packaged as a group for sale. For example, a package of displays could comprise ten or more displays for use in a small office environment or within a large distributed family. It is also contemplated that a package could include 100 or more displays possibly for large deployment, as in a globally distributed corporate environment for example.

Although in a preferred embodiment displays are assigned identifiers and formed into a group affiliation before sale, it is also contemplated that individual displays can also be sold separately and integrated into the group affiliation at a later time.

In a preferred embodiment a package includes DPFs. However, a package of displays can include a heterogeneous mix of displays types. For example, a package of displays could comprises DPFs of different makes, models, or sizes, or could comprise a mix of DFPs, monitors, televisions, or other types of electronic displays.

Video Conferencing

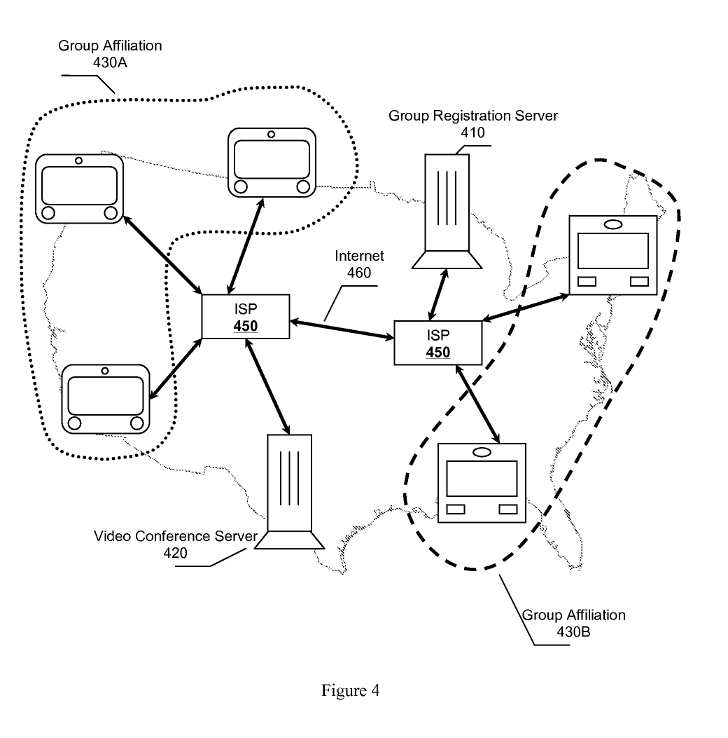

In FIG. 4, group affiliations 430A and 430B each have two or more member displays and each affiliation can support a video conference among its member displays over geographically significant distances (e.g., greater than 10 Km). Group affiliations 430A and 430B each represent a group of affiliated network enabled electronic displays, preferably DPFs, where each display of the group has an assigned identifier. Each group affiliation is formed as a function of the identifiers of the member displays. During a video conferencing session, only the displays within a group affiliation are allowed to exchange image data or audio data among other members of the group affiliation over a network (e.g., Internet 460). In the following discussion, only group 430A will be described with respect to the inventive subject matter. One skilled in the art will recognize that the examples provided can be equally applied to group affiliation 430B or other group affiliation having any number of displays without regard to their physical locations.

Displays within group affiliation 430A can access each other over a network using known techniques and protocols (e.g., TCP, UDP, SIP, H.323, HTTP, etc. . . . ). For example, displays within 430A can acquire IP addresses for use during a video conference among each other through the use of DHCP. The displays can contact each other via their IP address or through the use of DNS, or possibly Dynamic DNS. Member displays of group affiliation 430A can exchange video conferencing data over a network ISPs 450 and Internet 460. It is contemplated that group affiliation 430A can conduct a video conferencing session across any network including a LAN, WAN, VPN, wired network, or wireless network.

In a preferred embodiment, member displays of group affiliation 430A inform registration server 410 of their network address (e.g., IP address, URL, domain name, etc. . . . ). Registration server 410 preferably maps one or more display identifiers to their respective network addresses. Additionally, a member display can discover other affiliated members by sending a query to server 410, where server 410 responds with identifiers or network addresses of the affiliated displays. It is also contemplated that member displays of group affiliation 430A can discover each other over a local network possible through a discovery multicast message or a broadcast message without requiring the use of registration server 410.

Once at least a portion of the members of group affiliation 430A are aware of each other, a video conferencing session can begin. In one embodiment, member displays send image or audio data to video conferencing server 420, which in turns forwards the image or audio data to the other members of affiliation 430A. Such an approach provides support for video conferencing among a larger number of displays and provides for establishing a for-fee video conferencing service.

It is also contemplated that displays can communicate directly with each other without requiring an intermediary server. For example, members of group affiliation 430A can communicate with each other in a peer-to-peer manner without utilizing video conferencing server 420. In a peer-to-peer video conferencing each display exchanges image or audio data directly with other displays of group 430A. Peer-to-peer video conferencing does not necessarily scale to larger number of displays. However, it is contemplated that a reasonable number of displays (e.g., less than 10 displays) can support a peer-to-peer video conferencing using known or yet to be invented data compression techniques.

In another embodiment, a display can be established as a group leader which can operate as a central communication point without using an intermediary server. For example, the first display to request a video conference can be established as a group leader. Other members of group affiliation 430A can send image or audio data to the group leader, which can then forward the data to other members of group affiliation 430A. In a preferred embodiment, the displays of group 430A comprise sufficient software or firmware to support video conferencing through multiple methods including via server 420, through peer-to-peer exchanges, through a group leader, or any combination of the methods.

One should note that although video conference sever 420 and group registration server 410 are depicted as separate entities within FIG. 4, the servers can be the same single server or operate within a video conferencing service. In some embodiments, it is also contemplated that a software package can be sold that provides the functionality of the various servers and that can be installed in a home or corporate environment. Furthermore, server 410 or 420 could also include functionality to support management of group affiliation 430A where displays can be removed or added, or where interoperation policies can be defined, updated, or managed.

In a preferred embodiment, displays are allowed to exchange data once the displays are suitably authenticated or authorized to participate in a video conference among members of group 430A. Displays can use their identifiers to authenticate themselves with each other or with a video conferencing service. Any suitable form of authentication can be used including OpenID, SecureID™, RADIUS, Kerberos, passwords, or other authentication methods. It is also specifically contemplated, as previously discussed, that a display can use its identifier or portions of its identifier as a bypass for gaining permission to group functionality.

A video conferencing session can also be further secured beyond the mere use of authentication. In some embodiments, two or more displays within group 430A can employ data encryption to secure communications among each other. Suitable data encryption and key exchange algorithms include AES, DES, 3DES, RSA, ECC, or other known or yet to be invented algorithms.

Video conferencing as presented above provides for numerous advantages. One advantage includes the simplicity with which consumers can establish a video conferencing environment. The consumer can purchase displays preconfigured with a group affiliation without having to register or configure each display personally after purchase. Once the displays are deployed at their respective sites, the display can automatically contact a registration server. The consumer need only indicate that a video conference is desired. The displays and/or the associated server establish the necessary connections with little or no session configuration on the part of a consumer. Another advantage includes allowing the displays to exchange data while retaining the confidentially of the consumer. Consumer identification is not required for the system to support video conferencing because each display can be identified directly through its identifier and group affiliation.

Additional Considerations

The inventive subject matter is considered to include additional capabilities in addition to the concepts presented above. One capability offered by a video conferencing system as described above can include providing a “window” feature where each display can operate as a window into a remote location. For example, a geographically distributed family could have DPFs located in a home of each family member. The frames could remain turned “on” at all times so that all members of the family can see each other at any time during the day even though the members are not actively within a video conference. It is also contemplated that an interoperation policy could include scheduled times to turn “on” or “off” features of the frames. One member of the family could prefer to have their display “muted” to prevent capture of audio data while also allowing the camera of the frame to remain active. The policy can be configured to enable capture of audio data during scheduled times, perhaps during dinner time from 5:00 p.m. until 7:00 p.m. It is specifically contemplated that an interoperation policy can include support for permitting scheduled events.

An additional capability can include configuring displays to display remote images in desirable formats. In some embodiments, a single display can show image data from multiple remote displays by sectioning the screen into multiple windows or segments. Additionally, multiple displays can be located within the same location where each display only shows image data from one remote display in a manner were each local display shows data captured from a single remote display participating in a video conference. Furthermore, multiple displays can be aggregated together to form a single composite display.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for video conferencing, comprising:
providing a plurality of network enabled electronic displays;
assigning identifiers to each of the plurality of displays;
forming a group affiliation among at least a portion of the plurality of displays as a function of the identifiers;
packaging member displays of the group affiliation for sale as a group; and
allowing exchange of captured image data among member displays of the group affiliation over a network.

2. The method of claim 1, wherein the step of forming a group affiliation includes registering the at least a portion of the plurality of display with a group registration service.

3. The method of claim 1, further comprising discovering member displays of the group affiliation over the network.

4. The method of claim 1, further comprising removing a member display from the group affiliation.

5. The method of claim 1, wherein the step of assigning identifiers and forming a group affiliation occurs before initial sale of the group.

6. The method of claim 1, wherein the identifiers assigned to each of the plurality of displays have the same value.

7. The method of claim 6, wherein the same value represents a common group identifier associated with the group affiliation.

8. The method of claim 1, wherein the identifiers each comprise at least a 64-bit value.

9. The method of claim 1, wherein the step of exchanging image data directly occurs without requiring an intermediary server.

10. The method of claim 1, further comprising exchanging audio data directly among the member displays of the group affiliation over a network.

11. The method of claim 1, wherein the step of exchanging image data occurs in a peer-to-peer manner.

12. The method of claim 1, further comprising establishing a group leader from among the member displays.

13. The method of claim 12, wherein the step of exchanging image data occurs via the group leader.

14. The method of claim 1, wherein the electronic displays comprise digital picture frames.

15. The method of claim 1, further comprising automatically establishing a data exchange connection among the member displays.

16. The method of claim 1, further comprising providing a policy that governs an interoperation among the member displays.

17. The method of claim 16, further comprising updating the policy on the member displays.

18. The method of claim 1, further comprising bypassing an authentication of at least one of the member displays as a function of its identifier.

19. The method of claim 1, wherein the identifiers comprise hierarchical identifiers that have at least two levels.

20. The method of claim 19, where in each level corresponds to a bypass permission.
